(19) United States
(12) Patent Application Publication
(10) Pub. No.: US 2005/0163383 A1
(43) Pub. Date: Jul. 28, 2005

(54) Driver's eye image detecting device and method in drowsy driver warning system

(75) Inventors: Hee-Jung Kim, Seoul (KR); Ho-Jun Lee, Hwaseong-si (KR); Kyong-Ha Park, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/929,258

(22) Filed: Aug. 30, 2004

(30) Foreign Application Priority Data
Jan. 26, 2004 (KR) 4677-2004

(51) Int. Cl. G06K 9/00; G06K 9/62

(52) U.S. Cl. 382/209; 382/117

(57) ABSTRACT

A device for detecting a driver's eye image, which includes a camera for photographing a driver who is sitting in a car and outputting a photographed facial image of the driver, an eye template storing section for storing an eye template in the form of a standard human eye, and a control section for detecting an eye image from the driver's facial image inputted from the camera using the stored eye template. The device can rapidly obtain a driver's eye image for a drowsy driver warning system.

### PRIORITY

This application claims priority to an application entitled “Driver's Eye Image Detecting Device and Method in Drowsy Driver Warning System” filed with the Korean Intellectual Property Office on Jan. 26, 2004 and assigned Serial No. 2004-4677, the contents of which are hereby incorporated by reference.

### BACKGROUND OF THE INVENTION

1. Field of the Invention

The present invention relates to a drowsy driver warning system, and more particularly to a device and a method for detecting a driver's eye image for a drowsy driver warning system.

2. Description of the Related Art

Drowsy driver warning systems monitor whether a driver dozes off while driving and sound an alarm or open a car window to instantly awake the driver, thereby preventing a possible car accident caused by drowsy driving. Such systems generally detect an eye image from the driver's facial image inputted from a camera and determine whether the driver is dozing off based on the detected eye image.

Conventional methods for detecting a driver's eye image in a drowsy driver warning system compare brightness levels of the driver's facial image, as photographed by the camera, with reference levels. Such methods convert the image into binary data of a high brightness area (brighter area) and a low brightness area (darker area), form the low brightness area in a group of multiple pixels to detect the position of the eyes in the pixel group, and obtain an eye image from the driver's facial image based on the detected position of the eyes.

Another method used in conventional methods is to connect pixels in the driver's facial image on vertical lines to certain gray levels in order to form vertical bars, analyze positional information of each vertical bar, determine the position of each part of the face based on the relative position of each vertical bar according to preset data, and detect the eye positions in the image based on the relative position of each part of the face.

The former method for detecting a driver's eye image is disclosed in Korean Unexamined Patent Publication No. 2000-0061157. This method is not advantageous because it takes time to perform the binary conversion of a facial image and to determine brighter and darker areas in the binary image to form a group of pixels. The latter method is disclosed in Korean Unexamined Patent Publication No. 1999-0047663. This method also requires much time to estimate the distribution of the brightness levels over an entire facial image to form vertical bars and analyze positional information of each vertical bar to calculate the relative position of each vertical bar.

### SUMMARY OF THE INVENTION

Accordingly, the present invention has been made to solve the above-mentioned problems occurring in the prior art, and one object of the present invention is to provide a device and a method for rapidly detecting an eye image from a driver's facial image in a drowsy driver warning system.

Another object of the present invention is to provide a device and a method for rapidly detecting an eye image from a driver's facial image inputted from a camera in a drowsy driver warning system, using a previously stored eye template that has a form similar to the driver's eye.

In order to accomplish the above objects of the present invention, there is provided a device for detecting a driver's eye image, which includes a camera for photographing a driver sitting in a car and outputting a photographed facial image of the driver; an eye template storing section for storing an eye template in the form of a standard human eye; and a control section for detecting an eye image from the driver's facial image inputted from the camera using the stored eye template.

To accomplish the above objects of the present invention, there is provided a method for detecting a driver's eye image in a drowsy driver warning system, which includes reading a first eye template, consisting of pixels corresponding to a sclera and those corresponding to an iris-pupil area of a standard human eye, from an eye template storing section when a driver's facial image is inputted from a camera; detecting pixels identical to those included in the first eye template from the inputted driver's facial image, using the first eye template; and obtaining an eye image including the detected pixels.

There is also provided a method for detecting a driver's eye image in a drowsy driver warning system, which includes storing a second eye template in an eye template storing section; reading the second eye template stored in the eye template storing section when a driver's facial image is inputted from a camera; detecting pixels identical to those included in the second eye template from the inputted driver's facial image, using the second eye template; and obtaining an eye image including the detected pixels.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic view of a standard human eye;

FIG. 2 shows an eye template according to the present invention;

FIGS. 3A and 3B show an example of the structure of an eye template according to the present invention;

FIG. 4 is a block diagram of a drowsy driver warning system according to the present invention;

FIG. 5 is a flow chart showing a process of detecting a driver's eye image according to the present invention;

FIG. 6 is a representation of a process of detecting a driver's eye image using an eye template according to the present invention; and

FIG. 7 is a flow chart showing a process of detecting a driver's eye image using an eye template reflecting the features of a driver's eye.

### DETAILED DESCRIPTION OF THE PREFERRED EMBODIMENT

Hereinafter, a preferred embodiment of the present invention will be described with reference to the accompanying drawings. In the drawings, the same element, although depicted in different drawings, is designated by the same reference numeral or character. Although certain elements, such as a circuit device, are specifically defined in the following description of the present invention, it will be obvious to those skilled in the art that such definitions of elements are merely to improve understanding of the present invention and that the present invention can be carried out without such specific elements. Also, in the following description of the present invention, a detailed description of known functions and configurations incorporated herein is omitted to avoid making the subject matter of the present invention unclear.

According to the preferred embodiment of the present invention, a drowsy driver warning system detects an eye image from a driver's facial image using an eye template that has a form similar to a real human, or standard, eye.

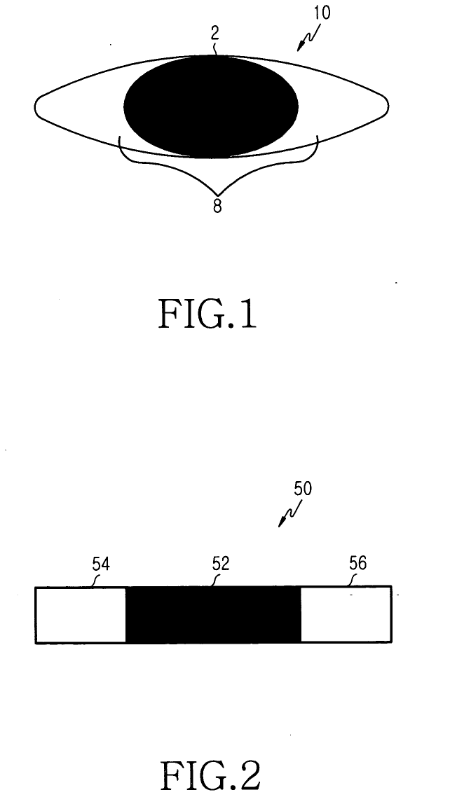

FIG. 1 is a schematic view of a standard human eye. FIG. 2 shows an eye template according to the present invention. Referring to FIG. 1, a human eye 10 has a white sclera 8 and an iris-pupil area 2 of the eye that includes an iris and a pupil. Generally, people of Asian heritage have an iris of a dark gray color, while Westerners often have irises of a brighter color. For purposes of describing the present invention, the iris-pupil area 2 is described as being dark gray. The iris-pupil area 2 is nearly circular. People commonly have eyes, which are slightly oval with a horizontal diameter of 12 mm and a vertical diameter of 11 mm. The sclera 8 is a white part of the eye that surrounds the iris of the iris-pupil area 2. In the preferred embodiment of the present invention, an eye template has a form similar to a standard human eye, as described above.

Hereinafter, the eye template according to the present invention will be explained in detail with reference to FIGS. 1 and 2. The eye template 50 is a group of pixels having a size and a form similar to a real, i.e. standard, human eye. The eye template 50 is composed of black pixels 52 corresponding to the iris-pupil area 2 of the eye and white pixels 54 and 56 corresponding to the sclera 8. Like the sclera 8 surrounding the iris-pupil area 2, the white pixels 54 and 56 are arrayed on the left and right sides of the black pixels 52. In other words, the eye template 50 arrays white pixels 54 on the left, black pixels 52 in its center and white pixels 56 on the right.

The eye template 50 having the above structure is used to detect an eye image from a driver's facial image photographed by a camera loaded in a drowsy driver warning system. The number of pixels in an eye image of a photographed driver's facial image varies depending on the focal length of a camera lens and the position of the camera. Therefore, it is preferable to determine the number of pixels included in the eye template 50 to correspond to the number of pixels in the driver's eye image which varies depending on the focal length of the lens and the position of the camera. For example, if the camera is adjusted to have a long focal length and is positioned far away from the driver, an eye image detected from the driver's facial image photographed by the camera will have a reduced number of pixels. In this case, it is desirable to reduce the number of pixels forming the eye template 50. If the camera is adjusted to have a short focal length and is positioned close to the driver, an eye image detected from the driver's facial image photographed by the camera will have a larger number of pixels. In this case, it is desirable to increase the number of pixels forming the eye template 50.

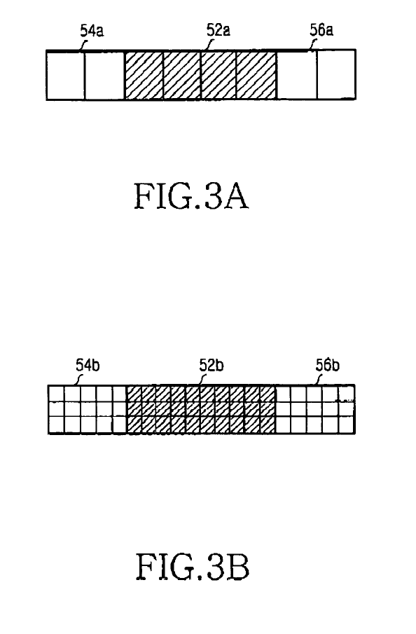

FIGS. 3A and 3B show an example of the structure of an eye template according to the present invention. FIG. 3A shows an eye template 50 having a small number of pixels (eight pixels). Referring to FIG. 3A, the eye template 50 is composed of two white pixels 54a corresponding to the left sclera, four black pixels 52a corresponding to the iris-pupil area of the eye including the iris and the pupil, and two white pixels 56a corresponding to the right sclera. FIG. 3B shows an eye template 50 having a larger number of pixels. Referring to FIG. 3B, the eye template 50 is composed of white pixels 54b corresponding to the left sclera, black pixels 52b corresponding to the iris-pupil area of the eye, and white pixels 56b corresponding to the right sclera.

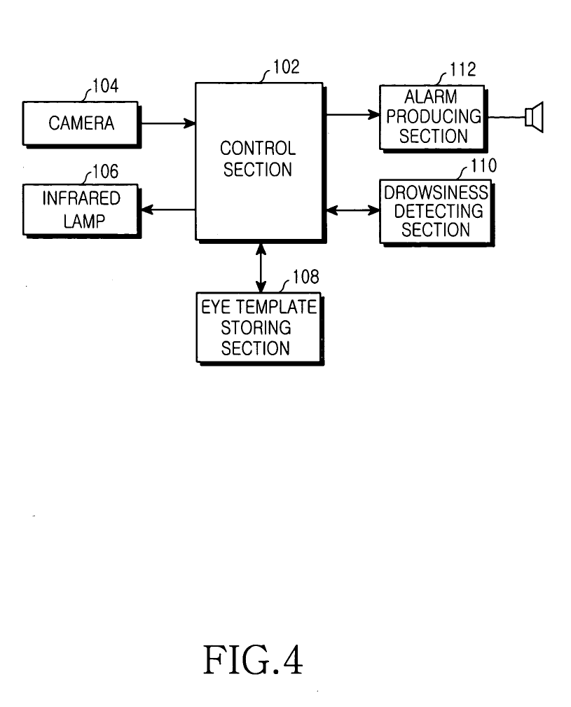

Hereinafter, the structure and operation of a drowsy driver warning system which obtains an eye image from a driver's facial image and detects drowsiness using the obtained eye image will be explained in more detail making reference to FIGS. 4-7.

FIG. 4 is a block diagram of the drowsy driver warning system according to the present invention. Referring to FIG. 4, the drowsy driver warning system includes a control section 102, a camera 104, an infrared lamp 106, an eye template storing section 108, a drowsiness detecting section 110 and an alarm producing section 112.

The control section 102 controls the overall operation of the drowsy driver warning system. The control section 102 monitors whether the driver dozes off while driving and sounds an alarm to instantly awaken the driver. To be specific, when a facial image of the driver is inputted, the control section 102 rapidly obtains an eye image from the facial image using the stored eye template 50, generates a new eye template based on the obtained eye image and stores the new eye template.

The camera 104 consecutively and continuously photographs the face of the driver and sends photographed facial images to the control section 102. The infrared lamp 106 outputs infrared light to brighten the face of the driver, thereby rendering sharply focused images.

The eye template storing section 108 stores the eye template 50 for obtaining an eye image from a photographed facial image of the driver. As explained above with reference to FIGS. 2 and 3, the eye template 50 is a group of pixels having a form similar to a human eye.

Under the control of the control section 102, the drowsiness detecting section 110 receives an eye image obtained using the eye template 50 and determines whether the driver is dozing off. For example, when the pupil expands beyond a predetermined size or the driver blinks frequently over a predetermined number of blinks for a predetermined period of time, the drowsiness detecting section 110 determines that the driver is dozing off. Otherwise, the drowsiness detecting section 110 determines that the driver is not sleepy. Upon such determination, the drowsiness detecting section 110 outputs determination results to the control section 102.

If the driver dozes off while driving, the alarm producing section 112 produces an alarm signal and outputs the alarm signal through the speaker under the control of the control section 102 in order to keep the driver alert.

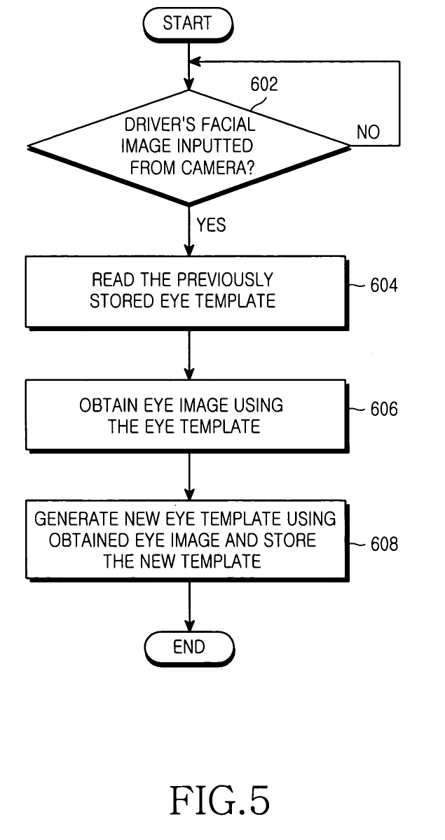

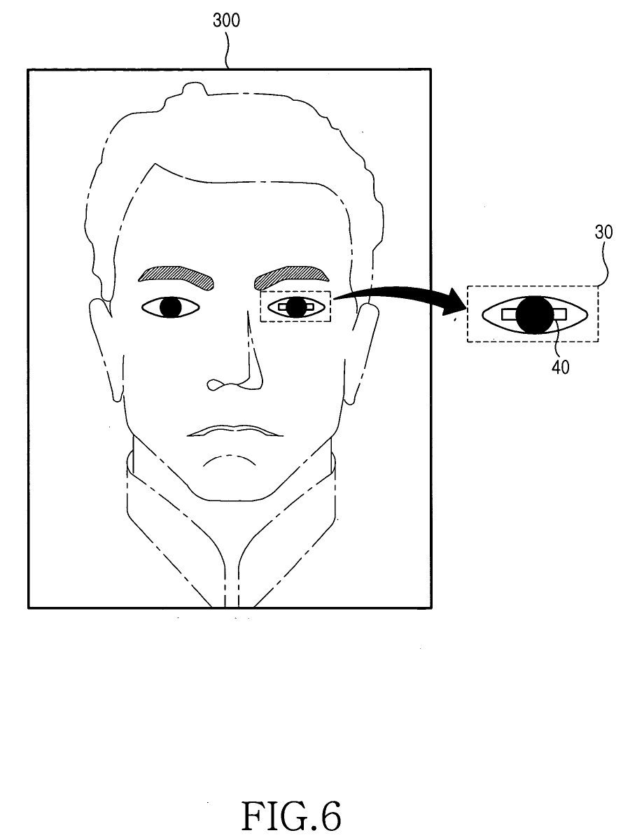

FIG. 5 is a flow chart showing a process of obtaining a driver's eye image according to the present invention. FIG. 6 explains a process of obtaining a driver's eye image using an eye template according to the present invention.

Hereinafter, a process of obtaining a driver's eye image using the eye template 50 in a drowsy driver warning system according to the present invention will be explained in detail with reference to FIGS. 2 to 6.

At step 602, the control section 102 determines whether a driver's facial image has been inputted from the camera 104. When a facial image 300 as shown in FIG. 6 is inputted, the control section 102 proceeds with step 604 to read the eye template 50 that has been previously stored in the eye template storing section 108.

Upon reading the eye template 50, the control section 102 proceeds with step 606 to obtain an eye image 30 from the driver's facial image 300 using the eye template 50. Specifically, the control section 102 compares the pixels in the driver's facial image 300 with those included in the eye template 50 and detects pixels 40 which are identical to the pixels included in the eye template 50 as shown in FIG. 6.

First of all, the control section 102 detects pixels, which are identical to the left white pixels in the eye template 50 by comparing the pixels in the driver's facial image 300 with the left pixels in the eye template 50, one after another. A predetermined block of pixels in the driver's facial image 300, beginning with the top left one, is compared with the left white pixels in the eye template 50. If those pixels in the driver's facial image 300 are not identical to the left pixels in the template 50, another block of pixels, which begins with the second pixel from left in the image 300, will be compared with the left pixels in the eye template 50.

If the control section 102 detects pixels, which are identical to the left white pixels in the eye template 50, it will compare pixels on the right of the detected pixels with the central black pixels in the eye template 50. If the comparison shows that the pixels on the right are not identical to the central black pixels in the eye template 50, the control section 102 will compare another block of pixels in the image 300 with the left white pixels in the eye template 50. If the control section 102 detects two adjacent blocks of pixels, which are identical respectively to the left white pixels and central black pixels in the eye template 50, it will compare pixels on the right of the detected blocks with the right white pixels in the eye template 50.

If the pixels on the right are not identical to the right white pixels in the eye template 50, another block of pixels in the image 300 will be compared with the left white pixels in the template 50. If the control section 102 detects three adjacent blocks of pixels, which are identical respectively to the left white pixels, central black pixels and right white pixels in the eye template 50, the control section 102 will complete the detection of the pixels 40 which are identical in structure to the pixels in the eye template 50.

Upon detecting the pixels 40 from the driver's facial image 300, the control section 102 obtains an eye image 30 in which the pixels 40 are included as shown in FIG. 6. At step 608, the control section 102 generates a second eye template using the obtained eye image 30 and stores the second eye template in the eye template storing section 108. In other words, the control section 102 uses an eye template newly stored in the eye template storing section 108 in order to obtain a new eye image from a subsequently inputted facial image. Since the new eye template is generated to correspond to the features of the driver's eyes, it can be used to accurately detect eye positions in the facial image.

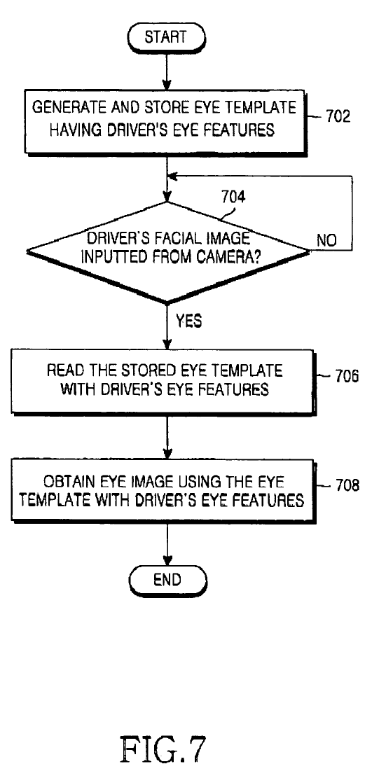

Hereinafter, a process of obtaining a driver's eye image using a newly-stored eye template in a drowsy driver warning system according to the present invention will be explained in detail with reference to FIG. 7. FIG. 7 is a flow chart showing this process.

Referring to FIG. 7, the control section 102 generates an eye template corresponding to the features of the driver's eyes and stores the eye template in the eye template storing section 108 at step 702. This step is identical to steps 602 to 608 in FIG. 5. After storing the eye template corresponding to the driver's eye features, the control section 102 proceeds with step 704 to determine whether a facial image of the driver has been inputted from the camera. When a facial image is inputted, the control section 102 proceeds with step 706 to read the eye template stored in the eye template storing section 108. At step 708, the control section 102 obtains an eye image 30 from the driver's facial image 300 using the eye template having the driver's eye features. To be specific, the control section 102 compares the pixels in the driver's facial image 300 with those included in the eye template storing section 108 and detects pixels 40 which are identical to the pixels included in the eye template 50, as shown in FIG. 6. The control section 102 can correctly detect eye positions in the facial image 300, using the eye template having the driver's eye features.

As explained above, the drowsy driver warning system according to the present invention obtains an eye image from a driver's facial image photographed and inputted from the camera, using an eye template that has been stored in advance. The drowsy driver warning system can rapidly obtain a driver's eye image and generate a new eye template reflecting the driver's eye features, using the obtained eye image. The new eye template is stored and used to obtain an eye image from a subsequently-inputted driver's facial image. Accordingly, it is possible to obtain a correct eye image from a facial image inputted from the camera.

Although a preferred embodiment of the present invention has been described for illustrative purposes, those skilled in the art will appreciate that various modifications, additions and substitutions are possible, without departing from the scope and spirit of the invention as disclosed in the accompanying claims, including the full scope of equivalents thereof.

1. A device for detecting a driver's eye image, which comprises:
a camera for photographing and outputting a facial image of a driver;
an eye template storing section for storing an eye template in the form of a human eye; and
a control section for detecting an eye image from the driver's facial image inputted from the camera using the stored eye template.

2. The device according to claim 1, wherein said eye template consists of pixels corresponding to a sclera area and pixels corresponding to an iris-pupil area of a standard human eye.

3. The device according to claim 2, wherein the number of pixels included in said eye template varies depending on a focal length of a camera lens and a position of the camera.

4. A method for detecting a driver's eye image in a drowsy driver warning system, which comprises:
reading a first eye template, which consists of pixels corresponding to a sclera area and pixels corresponding to an iris-pupil area of a standard human eye, from an eye template storing section when a driver's facial image is inputted from a camera;
detecting pixels identical to those included in the first eye template from the inputted driver's facial image, using the first eye template; and
obtaining an eye image including the detected pixels.

5. The method according to claim 4, further comprising generating a second eye template using the obtained eye image and storing the second eye template in said eye template storing section.

6. A method for detecting a driver's eye image in a drowsy driver warning system, which comprises:
storing an eye template in an eye template storing section;
reading the eye template stored in the eye template storing section when a driver's facial image is inputted from a camera;
detecting pixels identical those included in the eye template from the inputted driver's facial image, using the eye template; and
obtaining an eye image including the detected pixels.

7. The method according to claim 6, further comprising providing an alarm if comparison of the eye template to the obtained eye image determines that a pupil has expanded beyond a predetermined size.

8. The method according to claim 6, further comprising providing an alarm if comparison of the eye template to the obtained eye image detects a change in pupil size beyond a predetermined size.
